(19) United States
(12) Patent Application Publication
(10) Pub. No.: US 2014/0377503 A1
(43) Pub. Date: Dec. 25, 2014

(54) FIBER BOARD AND METHOD FOR MAKING FIBER BOARD

(71) Applicants: FIH (Hong Kong) Limited, Kowloon (HK); SHENZHEN FUTAIHONG PRECISION INDUSTRY CO., LTD., Shenzhen (CN)

(72) Inventors: YU-TSAI WANG, New Taipei (TW); WU LI, Shenzhen (CN); DA-QING HUANG, Shenzhen (CN); XUAN-ZHAN ZENG, Shenzhen (CN); ZHI-WEI HU, Shenzhen (CN); JIE CUI, Shenzhen (CN); QIANG ZHANG, Shenzhen (CN)

(73) Assignees: FIH (Hong Kong) Limited, Kowloon (HK); SHENZHEN FUTAIHONG PRECISION INDUSTRY CO., LTD., Shenzhen (CN)

(21) Appl. No.: 14/059,730

(22) Filed: Oct. 22, 2013

(30) Foreign Application Priority Data
Jun. 19, 2013 (CN) 2013102439752

(51) Int. Cl. B29C 43/18; B32B 3/26; B32B 5/02; B32B 7/04; B29C 43/52; B32B 27/12

(52) U.S. Cl. CPC B29C 43/18; B29C 43/52; B32B 27/12; B32B 5/02; B32B 7/04; B32B 3/266; B29C 2043/182; B29K 2069/00
USPC 428/139; 264/257; 264/493; 264/405; 428/412; 428/423.1; 428/215

(57) ABSTRACT

A method for making a fiber board includes the steps of, providing a fiber sheet and positioning the fiber sheet in a mold, providing at least one plastic sheet and locating the plastic sheet on a surface of the fiber sheet. Heating and melting the plastic sheet to make the molten plastic penetrate into the fiber sheet, and hot pressing the fiber sheet and the molten plastic to form the fiber board. A fiber board made by the method is also described.

### BACKGROUND

1. Technical Field

The present disclosure relates to a method for making fiber board and a fiber board made by the method.

2. Description of Related Art

Fiber materials are now widely used for electronic products, and sports products. The fiber materials are usually dipped in epoxy resin, allowing the epoxy resin to penetrate into the fiber materials to form fiber boards. However, the current method can be too slow for high-speed manufacturing methods.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a flow chart of a method for making a fiber board in accordance with an exemplary embodiment.

FIG. 2 is a cross-sectional view of the fiber board formed by the method shown in FIG. 1.

### DETAILED DESCRIPTION

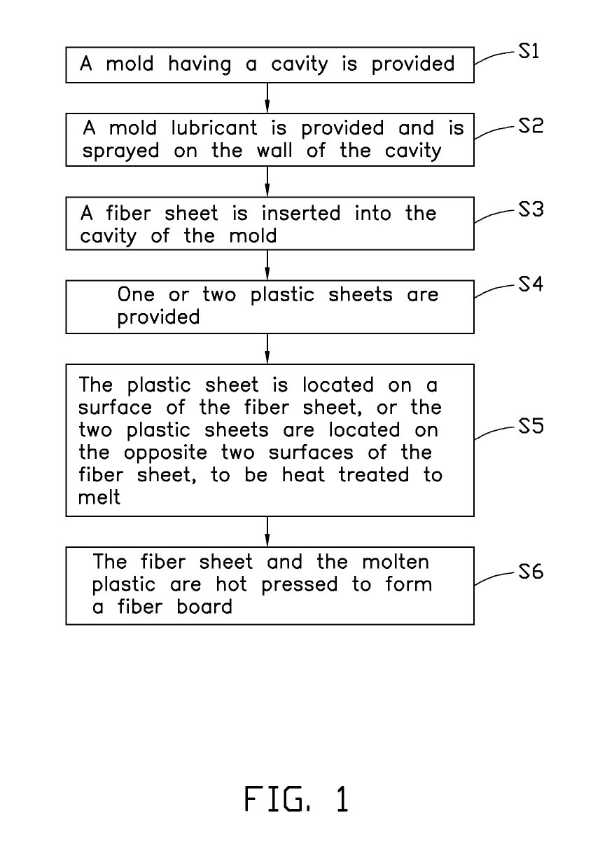

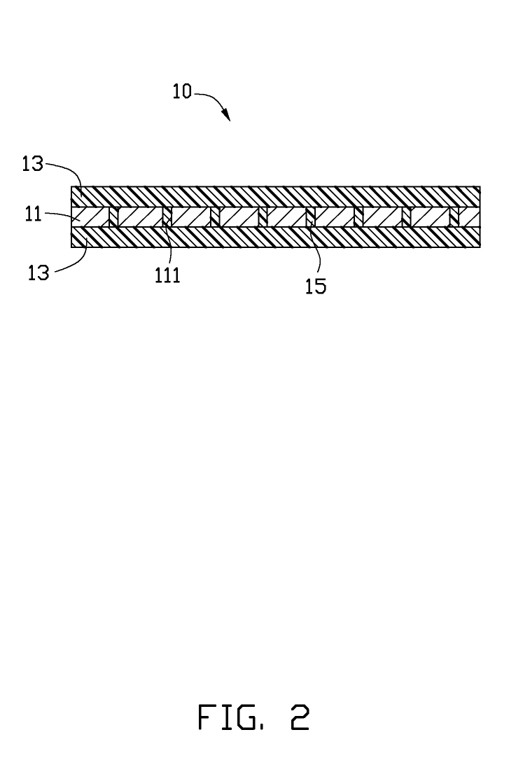

Referring to FIGS. 1-2, a method for making a fiber board 10 according to an exemplary embodiment includes the following steps.

Step S1, a mold (not shown) having a cavity is provided. The cavity is for receiving a fiber sheet 11. The fiber sheet 11 defines a plurality of through holes 111. The fiber sheet may be made of thermoplastic fiber, such as carbon fiber, glass fiber, or aramid fiber. The fiber sheet 11 may have a thickness of about 0.1 micrometer (μm) to about 0.3 μm.

Step S2, a mold lubricant is provided and is sprayed on the wall of the cavity. The mold lubricant can be ordinary lubricant.

Step S3, the mold is heated to an internal temperature of about 200° C. to about 250° C. Then, the fiber sheet 11 is inserted into the cavity of the mold.

Step S4, one or two plastic sheets (not shown) having a shape matching the shape of the fiber sheet 11 are provided. The plastic sheet may be made of thermoplastic polyurethane (TPU), or polycarbonate (PC).

Step S5, the plastic sheet is located on a surface of the fiber sheet 11, or the two plastic sheets are located on the opposite two surfaces of the fiber sheet 11, to be heat treated to melt. The heating treatment may be carried out by infrared light irradiating the plastic sheet(s) or by electrically heating the plastic sheet(s), at a temperature of about 350° C. to about 450° C. for about 0.5 minutes (min) to about 2 min. After the heating treatment, the plastic sheet(s) melts and penetrates into the through holes 111 of the fiber sheet 11, and the air in the through holes 111 is displaced by the penetrating molten plastic.

Step S6, the mold is closed. The fiber sheet 11 and the molten plastic are hot pressed under a pressure of about 40 kg/cm² to about 60 kg/cm² and an internal mold temperature of about 200° C. to about 250° C. for about 0.5 min to about 1 min. During the hot pressing process, the molten plastic forms a plastic film 13 on the surface of the fiber sheet 11, or two plastic films 13 on the opposite two surfaces of the fiber sheet 11, and a connecting layer 15 in the through holes 111 to connect the plastic film(s) 13 and the fiber sheet 11. As such, the fiber board 10 is finished. The plastic film 13 has a thickness of about 0.1 millimeter (mm) to about 0.3 mm. The air in the through holes 111 of the fiber sheet 11 is displaced during the hot pressing process, thus the fiber board 10 is pore-free, and the plastic film(s) 13 has a smooth surface.

The fiber board 10 made by the method above includes the fiber sheet 11, and the plastic film(s) 13. The fiber sheet 11 defines a plurality of through holes 111 in the fiber sheet 11. The through holes 111 are filled with plastic to form a connecting layer 15 which connects the plastic film(s) 13 and the fiber sheet 11.

The fiber sheet 11 is made of thermoplastic fiber, such as carbon fiber, glass fiber, or aramid fiber. The fiber sheet 11 may have a thickness of about 0.1 μm to about 0.3 μm.

The plastic film 13 has a smooth surface, and is also pore-free. The plastic film 13 may be made of TPU or PC and has a thickness of about 0.1 μm to about 0.3 μm.

Adhesion resistance of the plastic film 13 has been tested using a cross-cut method. The test indicated that only about 0% to about 4% of the plastic film 13 peeled off.

Compared to the current method, the exemplary fiber board 10 can be more quickly and effectively finished for the heating to melt process and the hot pressing process. Further, the fiber board 10 is pore-free, has smooth surface, and excellent adhesion resistance.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for making a fiber board, comprising:
providing a fiber sheet having through holes and positioning the fiber sheet in a mold;
providing at least one plastic sheet and locating the plastic sheet on a surface of the fiber sheet;
heating and melting the plastic sheet to make a portion of the molten plastic penetrate into the through holes of the fiber sheet; and
hot pressing the fiber sheet and the molten plastic to form the fiber board in which the portion of the molten plastic penetrating into the through holes of the fiber sheet forms a connecting layer connecting the fiber sheet and a plastic film formed on the fiber sheet by the plastic sheet.

2. The method as claimed in claim 1, wherein the heating process is carried out by infrared light irradiating the plastic sheet or by electrically heating the plastic sheet.

3. The method as claimed in claim 1, wherein the heating process is carried out at a temperature of about 350° C. to about 450° C. for about 0.5 min to about 2 min.

4. The method as claimed in claim 1, wherein the hot pressing process is carried out under a pressure of about 40 kg/cm² to about 60 kg/cm² and a temperature of about 200° C. to about 250° C. for about 0.5 min to about 1 min.

5. The method as claimed in claim 1, wherein the plastic sheet has a thickness of about 0.1 μm to about 0.3 μm.

6. The method as claimed in claim 1, wherein the plastic sheet is made of thermoplastic polyurethane or polycarbonate.

7. The method as claimed in claim 1, wherein during the hot pressing process, at least one plastic film is formed on the surface of the fiber sheet and the connecting layer formed in the through holes connects the fiber sheet and the plastic film.

8. A fiber board, comprising:
a fiber sheet;
a plastic film formed on a surface of the fiber sheet; and
a connecting layer connecting the fiber sheet and the plastic film.

9. The fiber board as claimed in claim 8, wherein the fiber sheet defines a plurality of through holes, the connecting layer is filled in the through holes and is made of the same plastic as the plastic film.

10. The fiber board as claimed in claim 8, wherein the fiber sheet and the plastic film respectively has a thickness of about 0.1 mm to about 0.3 mm.

11. The fiber board as claimed in claim 8, further comprising another plastic film formed on the opposite surface of the fiber sheet, the connecting layer connecting the fiber sheet and the two plastic films.
